(19) United States
(12) Patent Application Publication
(10) Pub. No.: US 2010/0006438 A1
(43) Pub. Date: Jan. 14, 2010

(54) WATER PURIFICATION PROCESS

(75) Inventors: Peter P. ANTICH, Richardson, TX (US); Lee A. BULLA, JR., Pilot Point, TX (US)

Correspondence Address: MORRISON & FOERSTER LLP, 12531 HIGH BLUFF DRIVE, SUITE 100, SAN DIEGO, CA, 92130-2040, US

(73) Assignee: Biological Targets, Inc., Pilot Point, TX (US)

(21) Appl. No.: 12/501,370

(22) Filed: Jul. 10, 2009

Related U.S. Application Data
(60) Provisional application No. 61/080,225, filed on Jul. 11, 2008.

(51) Int. Cl. C02F 1/469

(52) U.S. Cl. 204/522; 204/633

(57) ABSTRACT

An efficient system for desalinization of water is described wherein multiple stages of deionization result in drinking water quality and provision is made for recycling wastewater through the system.

### CROSS-REFERENCE TO RELATED APPLICATION

This application claims priority to U.S. application Ser. No. 61/080,225 filed 11 Jul. 2008. The contents of this application are incorporated herein by reference.

### TECHNICAL FIELD

The invention relates to techniques for purification of water, in particular purification of sea water, or brackish water for domestic uses or irrigation, and of municipal supply water for applications in the electronics industry. The process is a particularly designed single or multistage deionization process in which a stage has a basically three compartment structure: one anionic and one cationic “waste” water compartment enclosing a single deionized central compartment. The deionization cells are integrated with auxiliary filters and electronic controls that maximize efficiency and result in high-quality water. The system has been termed step-wise continuous deionization (SCDI) with a trademark of Waterwheel™.

### BACKGROUND ART

There is a well-recognized need to convert sea water or brackish water into water that has sufficient quality to provide drinking water. Many desalinization techniques are currently available, but they have serious disadvantages, not the least of which are high energy requirements, low water quality and excessive fractions of waste water. Although distillation and freeze/thaw techniques provide high water quality and low waste, the energy cost is extremely high, and the purified water may be inappropriate for electronic applications (e.g. there may be excessive residual ion concentrations). The energy costs are lowered somewhat in the case of reverse osmosis and unstaged deionization, but they result in waste water of excessive salinity and current electrodialysis devices, in particular, result in low water quality. This appears to be due to an incomplete system design and to inadequate control of the process.

The present invention combines very low energy requirements and costs with very high water quality through control of a multistep, but continuous, desalinization process that employs multiple deionization components and completes them with methods for removing biological contaminants (e.g., bacteria, algae), controlling acidity and treating wastewater.

### DISCLOSURE OF THE INVENTION

The invention employs a multiplicity of deionization chambers or cells that can, if desired, be powered ultimately using solar or wind power. The process transfers ions from a compartment containing increasingly deionized or “purified” water to two waste water compartments, typically flanking it, one containing increasing concentrations of anions, and the other of cations. Each waste-water compartment may be further divided into two or more subcompartments, containing increasing concentration of ions. The size of these compartments can be increased or decreased to increase or decrease the ion concentration but the number of ions exchanged between “purified” and “waste” water compartments depends upon membrane properties and the total space charge in the two compartments separated by it. When the power used by the device is kept constant the initial step of deionization is conducted only until a point of diminishing returns is achieved; the partially desalinated water is then in most embodiments transferred to at least a second step which can further remove ions at a higher efficiency than would have been possible in a single step. In multistage embodiments, each stage operates in series with the first.

Thus, in one aspect, the invention is directed to an apparatus for desalinization of water which comprises a multiplicity of deionization chambers (each with three or more compartments) such that subsets of the chambers can be operated in parallel and/or in series configurations to deplete the ion content of water in the central compartment of each chamber until such time as the process results in a smaller output when the demand for power is kept constant. The apparatus then optionally passages the partially ion-depleted water to a second stage for further deionization, resulting in further ion depletion. In concert with this, the waste-water volumes from the first stage could be combined and discharged or, in applications where wastewater must be further reduced, treated further as described below. The apparatus contains sufficient deionization chambers both in series (different stages) and in parallel (same stage) such that water of the desired quality and volume is ultimately obtained from the apparatus. The apparatus further contains a control unit to determine the level of depletion at which the partially depleted water is moved to a second stage or further stage of deionization.

In another aspect, the invention is directed to a method to purify water using the apparatus of the invention. In addition to the essential components described above, the apparatus may contain further features such as activated carbon filters, sedimentation tanks, sterilization chambers based on nanophase materials, and the like, that increase the quality of the purified water. The units if operated in series also permit recycling of wastewater to result in purified water and water with enhanced ion content. Because these methods are more efficient at high ion concentrations, the wastewater concentration can be increased using the same unit.

In any deionization cell, ions are removed from one compartment and sent to the two others flanking it. The two compartments are not added and mixed. This aspect, among others, differentiates the method from conventional electrodialysis which employs multiple membranes and in general results in two constituents: purified water and wastewater. In the SCDI design the two separate compartments contain ions of different charge; when the concentrations are too high, these cause the decrease in efficiency. The waste water can be deionized in two different process streams. To deplete positive metallic ions, either an electroplating method may be employed which plates them on one or more electrodes thus permitting easy removal or a chemical process such as saponification may be introduced to sequester the ions and thus re-purify the waste water; in addition the production of hydrogen ions (hydrolysis) is minimized as the ions are neutralized at the negative electrode and escape as hydrogen gas, which can be used to generate energy by burning in air. To deplete negative ions chemical methods are employed. In particular chlorine (neutralized at the positive electrode) escapes as a gas which can be trapped by bubbling it through a solution of sodium hydroxide and precipitated. Numerous other uses exist for the “waste water”: the separated materials can be used to destroy organic contaminants either in its pure or a treated form.

The application to water ultrapurification for the electrtonics industry poses different problems, in particular a difficult start to the deionization process itself. To overcome this problem the water is heated to 40°-50° C., resulting in a higher conductivity which facilitates the deionization process. Heating the water to a temperature higher than 50° C. may affect the membranes negatively.

### BRIEF DESCRIPTION OF THE DRAWINGS

FIG. 1 shows a diagrammatic view of a two-stage desalinization process which reduces the conductivity of the entering water by 17.5 mSi at each stage. Thus, by the second stage, the conductivity has been reduced by 34.75 mSi. One-fourth of the initial water is drinkable at the second stage and the rest is returned as wastewater.

FIG. 2 shows a graph which tracks the change in conductivity as a function of time under constant applied power. This graph indicates that once a point of diminishing returns is reached, the conductivity remains essentially constant. At this point, the partially desalinated water is passed to the next stage of desalinization.

FIG. 3 is a diagrammatic view of the two-stage SCDI apparatus that incorporates a filter that permits recycling of what would otherwise be wastewater. As shown, the stepwise continuous deionization can be expanded and enlarged depending on the application. It can be incorporated with traditional water purification devices such as sedimentation filters.

FIG. 4 shows a similar but more complex system compared to that in FIG. 3 with the sediment filter included to remove small particles from the influx water.

FIG. 5 is a photograph of a prototype unit according to the invention.

FIG. 6 is a schematic of the overall device.

FIG. 7 is a schematic of the current monitoring circuitry.

FIG. 8 is a schematic of the microprocessor and relays to control current.

FIG. 9 shows the on-off controls for the deionization cells.

FIG. 10 is a graph showing a comparison of output of the device when cells are operated with only a single phase as compared to two stages.

FIG. 11 shows a modular element from one design of the apparatus of the invention.

FIG. 12 shows details of a single cell of the modular construction shown in FIG. 11.

FIG. 13 shows further details of the construction of a single compartment of such cell.

FIG. 14 shows an assembly of the modules of FIG. 11.

FIG. 15 shows the circuitry with regard to a single compartment.

FIG. 16 shows circuitry for the filling and drainage of the “pure” compartments in two stages.

### MODES OF CARRYING OUT THE INVENTION

The step-wise continuous deionization (SCDI) process and apparatus are designed to carry out desalinization/deionization in at least two stages and to provide for the recycling of the wastewater resulting from each stage. The at least two stages are designed to be conducted in an energy-efficient manner, such that when the point of diminishing returns is reached with regard to the initial stage of deionization, the partially deionized water is passed on to the next stage to permit more efficient further deionization.

By “diminishing returns” is meant the point at which the rate of conductivity decrease has slowed from its initial rate when the applied power is kept constant using regulators. This term is used in an approximate sense as variations may occur that are simply “noise.” Further, stating that a change of stages occurs at the point of diminishing returns does not imply an exact point, but rather a point chosen to use the device efficiently to produce a desired flow of purified water.

The basic unit of the apparatus is an deionization cell which is divided into three compartments separated by ion exchange membranes. Water entering the cell is subjected to a low-voltage differential such that positive ions pass through a membrane that permits only the passage of positive ions toward the cathode and anions pass through a membrane that is permeable only to negative ions proximal to the anode. The voltage differential applied to a cell or to a multiplicity of cells in parallel is of the order of 9-12 V. Thus, water containing a surplus of positive ions accumulates in the compartment between the positive ion-passaging membrane and the cathode and water containing increased levels of negative ions accumulates in the compartment between the relevant membrane and the anode. The central compartment between the two membranes is thus reduced both in positive and negative ions.

The membranes selected for the chambers are commercially available. Typical membranes that permit passage of positive ions include the anionic and cationic ion exchange membranes commercially available from Asahi. Preferred choice for the cation exchange membrane is commercially available CM17000 and for the anion exchange membrane AM17000, both made by Membranes International, Inc. of Glen Rock, N.J. Membranes suitable for use in the cells that comprise the apparatus of the invention are also described in U.S. Pat. No. 6,814,865, U.S. Pat. No. 7,045,062, publication No. 2004/0198849 and publication No. 2006/0124537. The contents of these documents are incorporated herein by reference.

Membranes have intrinsic limitations in their ability to transfer ions between adjacent compartments when the gradient concentration is excessive (when the output compartment has excessive concentration, the osmotic pressure at the interface impedes ion transfer). This effect is overcome by inserting further membranes into the “waste” compartments to achieve a more gradual gradient of ion concentration in the resulting subcompartments, as when the gradient in ion concentration between adjacent compartments is smaller the limitation is mitigated. Thus, in effect, each cell may have more than two waste compartments.

As noted above, the operation of the deionization cells will result, eventually, in diminishing returns—i.e., a slow-down in deionization. This is due to the ability of the flanking, lateral cells to operate as a battery opposed to the applied voltage as the concentrations of the waste components (ions) in the outside compartments increase. Thus, for any combination of voltage, current, and initial conductivity, the resulting reduction in conductivity in the central compartment is not uniform but has a fast depletion phase followed by a slow refractory phase. Increasing the current or voltage to overcome the slowing is counterproductive because it effects hydrolysis with excessive production of hydrogen and OH radicals as well as chlorine gas. In addition, there are oscillations in the decrease in conductivity because ion depletion also occurs at the electrodes (due to the operation as a counter-weighting battery), while ion depletion in the central compartment occurs by ion exchange at the membranes, which is opposed by the accumulation of ions in the lateral compartments.

To obviate the waste, a circuit that limits the deionization to the phase before limiting dilution occurs, is employed to empty the compartments into the next stage.

Thus, each stage decreases the central compartment's salinity by 5-20 mSi (10-20% of sea water), which has been experimentally determined as efficient. The exact decrease depends on many factors, including the power applied, and the starting water composition and quality. Water quality can further be controlled, if desired, by prefiltration, sedimentation, and the like.

The disposition of the wastewater from the flanking compartments can be determined according to the option of the practitioner. The contents of the compartments can be mixed to precipitate salts and the concentration of the ions in the waste chambers can be controlled by controlling their dimensions—i.e., by making these thinner, the concentration is increased due to a decrease in volume. Alternatively, the waste compartments can be arranged as a battery and energy harvested. If arranged as a battery, hydrogen is produced by reduction of hydrogen ions or metal by reduction of metal ions in the cationic compartment and, for example, chlorine gas generated in the anionic compartment by oxidation of chloride ions. Various dispositions of these materials may be employed.

The method and apparatus of the invention employ multiplicities of the deionization cells of this type. By “multiplicity” is meant at least two, but “multiplicity” can include more than two and is dictated by the volume of water that must be treated. This modular architecture permits scaling of the device to fit requirements. Typically, the number of cells employed in parallel diminishes with succeeding stages in the deionization because the purified water volume is less than that of the input water.

In principle, sufficient stages are performed to lower the salt concentration to an acceptable level represented by a conductivity of 0.75 mSi or less in accordance with WHO limits for drinking water or to a level suitable for irrigation.

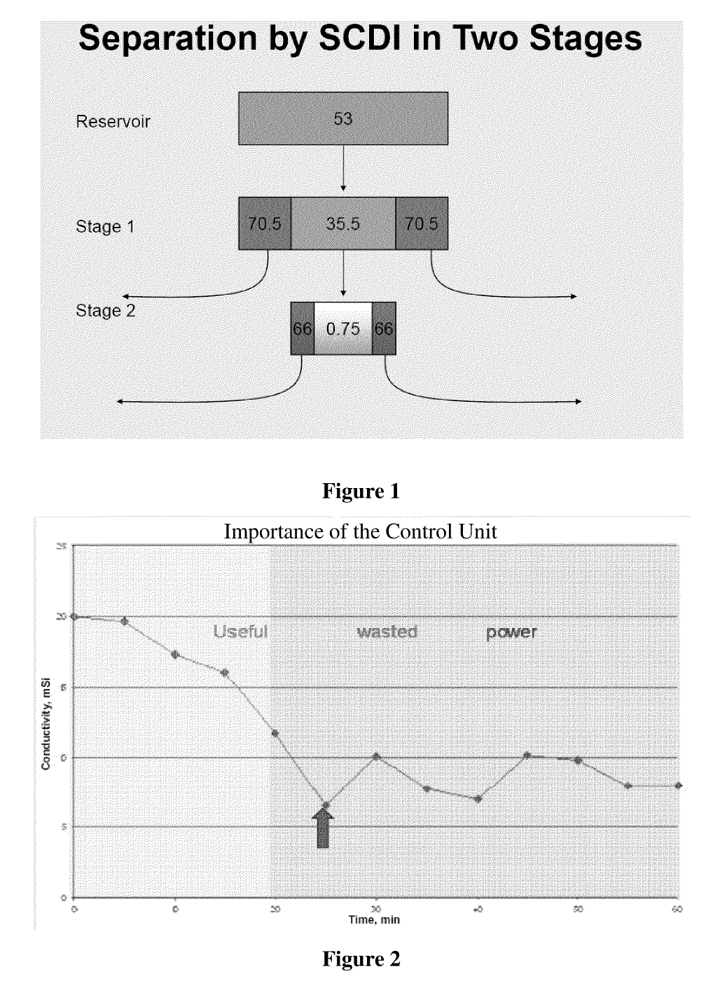

FIG. 1 shows a schematic representation of this process in two stages. The initial conductivity of the water in the reservoir fed into stage 1 is elevated, e.g., 53 mSi for sea water and in the first stage the conductivity in the central compartment between the two membranes is lowered to 35.5 mSi while the flanking compartments that occupy the space between the membranes and the electrodes have increased conductivities, in this case 70.5 mSi. When these levels are achieved, the efficiency begins to decrease and the water in the central compartment is passed to stage 2 where, again, the conductivity is decreased in the central compartment while the conductivity in the outer compartments is enhanced. (The figure legend states decreases of 17.5 mSi for each stage, thus at the exit of the second stage the decrease is 2×17.5=35 mSi.)

In this illustrative embodiment, as shown by the arrows drawn to the side in FIG. 1, the “waste” water from the bracketing compartments is combined into a single compartment with enhanced conductivity and recycled.

As shown in FIG. 2, by sensing a slowdown in the decrease in conductivity—i.e., “diminishing returns”, energy waste that would occur if the voltage differential were applied continuously, is prevented by transferring the water to the next stage where more efficient ion removal takes place. Typically, the first 15-20 minutes of operation at constant power (for example, 6 W) remove about half the ions, and beyond this, energy is wasted. The “switchover” is due to the accumulation of charges in the two waste compartments; which partially screen the electrodes and reduce the voltage in the “purified water” compartment between the ion-exchange membranes. The decreased influx of ions into the waste compartments limits the ion removal process. The ion removal processes may be engineered as outlined above to passage the purified volume alone to a second stage. Ion removal from the waste compartments increases the duration and energy consumption; a simple increase in voltage and current results in excessive volumes of unwanted gases, e.g., hydrogen and chlorine and in excessive power consumption; the most economic and safe configuration to obviate this problem is to add a second stage.

As shown in the graph, when power begins to be wasted, after being under constant power of 5-12 V during the first 15-25 minutes of operation, wherein approximately half of the ions have been removed, the control unit senses the slowdown in ion removal and automatically stops the process and transfers water to the next stage.

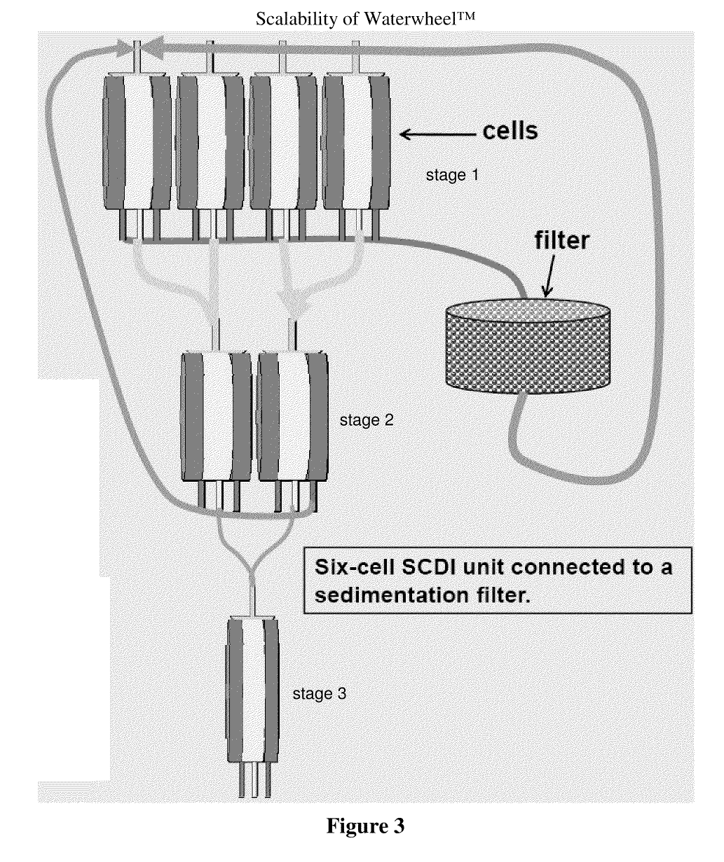

The efficiency and capacity of the apparatus is further improved by employing a multiplicity of the deionization chambers as described above for each stage of desalinization. FIG. 3 shows one embodiment of this expansion, but, of course, the number of cells at each stage is arbitrary and the number can be expanded or decreased depending on the application desired and the amount of water that needs to be deionized. As shown in FIG. 3, the first stage employs four cells, which are exposed to a voltage differential of approximately 9-12 V to create the charge separation required for mobility of the positive and negative ions. As shown in FIG. 3, the partially deionized water from the central compartment of each cell is fed into stage 2 cells which itself contains two similar cells. The wastewater with higher ion content from the outer compartments of stage 1 cells is fed into a filter which effects precipitation of salt to a sufficient degree that the water can be returned, as shown, to the system. Because the second stage results in acceptably low concentrations of ions to permit the wastewater to be recycled directly, this wastewater is returned directly to stage 1.

The purified water from the central compartments of stage 2 can be further purified, if desired, in a third stage as shown in FIG. 3. Stage 3 is optional in the apparatus of the invention.

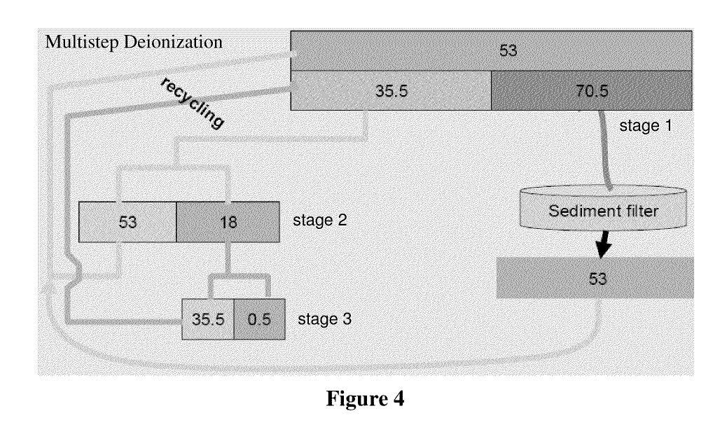

FIG. 4 shows another embodiment of the invention where the saltwater conductivity is reduced to the acceptable conductivity of potable water of 0.75 mSi by incrementally decreasing salinity about 17.5 mSi in each step. This system, as does that in FIG. 3, employs a sediment filter to permit recovery of the wastewater which is, itself, further returned to the system for desalinization. In a typical operation of a system such as this, the time required to produce pure water is approximately 45 minutes.

In FIG. 4, the two compartments containing higher concentrations of positive ions and negative ions are collapsed and shown in a single box. Thus, in stage 1, the partially purified water has a conductivity of 35.5 mSi, and the wastewater, by virtue of treatment with a sediment/filter, is reduced to a conductivity of 53 mSi, thus lowering the conductivity sufficiently to return this water to stage 1. The purified water from stage 1, which has a conductivity of 35.5 mSi, is then passed to stage 2 which reduces the conductivity further to 18 mSi resulting in “waste” water of 53 mSi which can be returned to stage 1. The partially purified water from stage 2 is then passed to stage 3 where the conductivity is lowered to 0.5 mSi (acceptable for drinking) with a wastewater content of 35.5 mSi which can be returned to the partially desalinated water compartment of stage 1 for further recycling.

The inclusion of a filter or other means for reducing the salinity of the wastewater from at least stage 1 is required in the system in order to permit all of the water to be recycled. The “filter” may also be a sedimentation tank; in any case, the salts and possibly other contaminants are precipitated and removed. The salt concentration in the wastewater is precipitated by, for example, lowering the temperature sufficiently to effect precipitation or by adsorption onto an ion exchange resin. Any convenient method to effect salt precipitation is workable.

Thus, the filter or sedimentation tank will include provision for these means to effect precipitation of salts.

The multistep process shown in FIG. 4 reduces salt water with a conductivity of 53 mSi to potable water with a conductivity of 0.75 mSi by incrementally decreasing salinity by about 17.5 mSi in each step. The water in the high saline compartment which results from the first stage at a conductivity of 70.5 mSi is treated and passed through a salt sedimentation filter and then recycled. The water from the first stage at lower salinity undergoes further deionization.

Thus, there is no wastage of water in this scheme and power usage is more efficient than continuous processes. The time required to produce pure water is about 45 minutes.

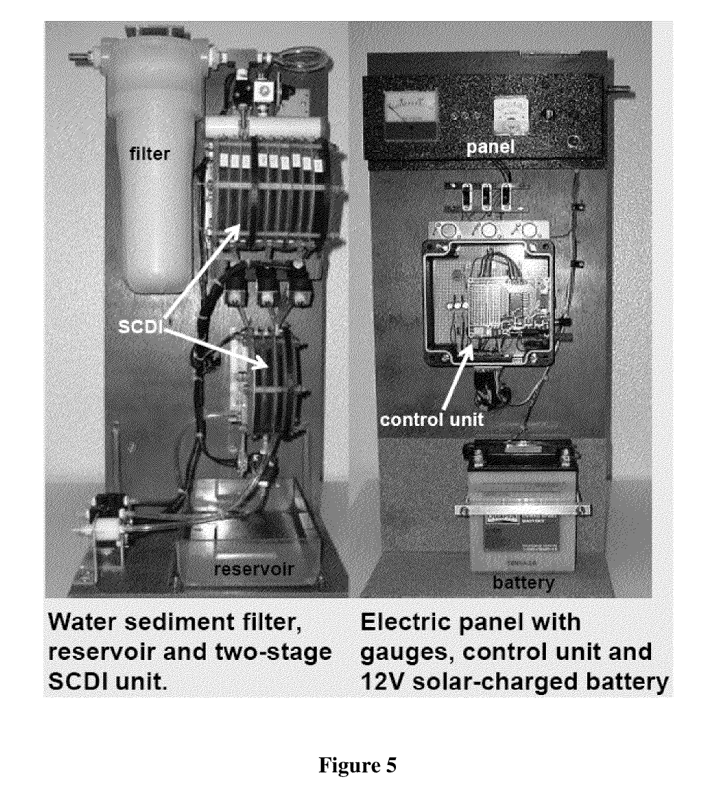

FIG. 5 shows a prototype of the apparatus of the invention which includes a 12 volt battery and a control unit and panel that permits effecting movement of water from stage 1 to stage 2 at the appropriate point of diminishing returns. These features are shown on the right. On the left is shown the front of the unit with multiple parallel deionization cells at stages 1 and 2, a reservoir for feeding the seawater or brackish water into stage 1 and a filter for recycling.

This illustrative embodiment consists of four cells, each consisting of the three required chambers. There are three cells on the top row and one cell on the bottom. As described above for each cell, there are 3 compartments: two waste water compartments flanking a pure water compartment. Initially, all compartments in all cells are filled with the source water to be purified. After processing, the waste water in the top three cells and the bottom cell is drained, the source water in the bottom cell is drained and discarded, and the pure water from the top three cells is used to fill all three compartments of the bottom cell. All three of the top cells are then refilled with source water and processing restarts. This time, instead of discarding the water from the central compartment of the bottom cell, it is drained into a pure water container, having been processed in both the top cell bank and the bottom cell. All the waste water is again drained, the water from the central compartment of the top cells drained into all three compartments of the bottom cell, and the top cells are refilled with source water. Each compartment in each cell holds 100 ml of water.

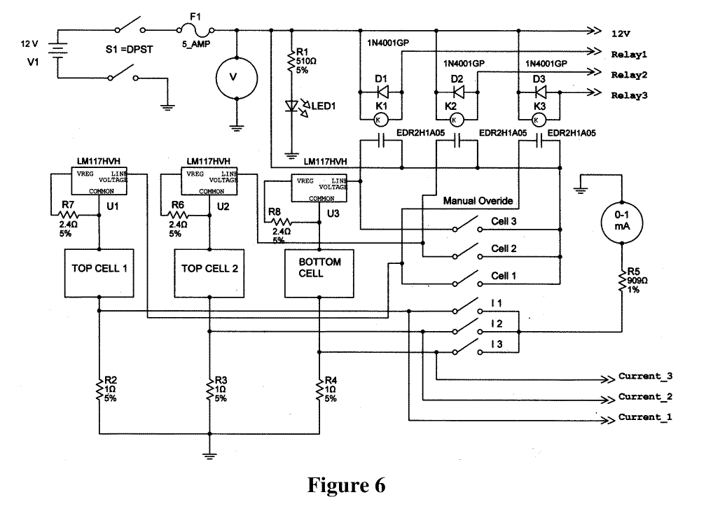

FIG. 6 shows a schematic of the device which is operated from a 12-volt battery that can be charged from a solar panel. The center top cell one shares a stainless steel cathode and graphite anode with the flanking cells. (Two top cells are shown, but there are actually three.)

LM117 (FIG. 6) integrated circuits are set up as constant current regulators supplying 0.5 amperes to each cell. There are relays (K1, K2 and K3) to switch current on for each cell, and manual override switches for testing. There are analog meters to measure the cell current and voltage. The current starts out at the maximum 0.5 amperes, but decreases as processing continues, and can be observed on the current meter by pressing the corresponding I1, I2 and I3 switches. The voltage meter simply monitors the charge state of the battery.

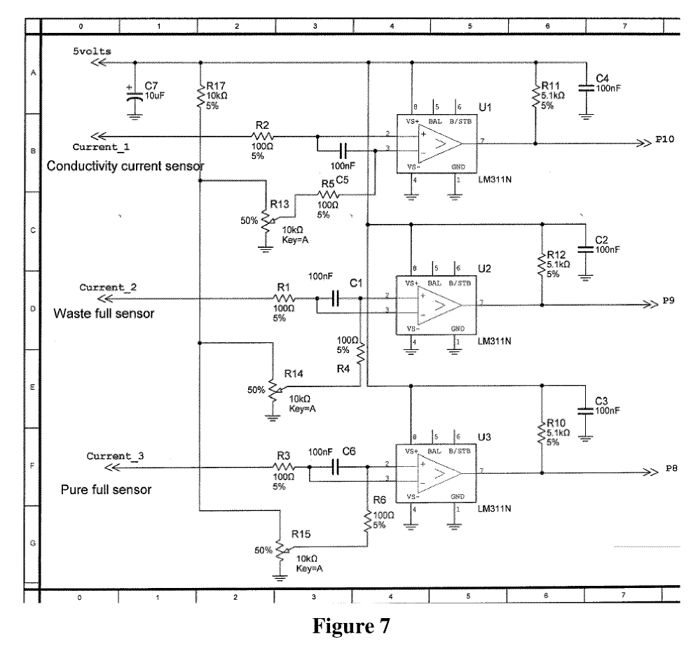

The current monitoring circuitry used to determine whether the cells are full or empty is shown in FIG. 7. The current is sensed by resistors R2, R3, and R4, converted into a voltage, and sent to the plus inputs of LM311 comparators. The current_1, current_2, and current_3 values are compared to the preset levels on the minus input, and if the current sensed is above the preset level, the cell is full of water. The preset levels are adjustable for different water conductivities.

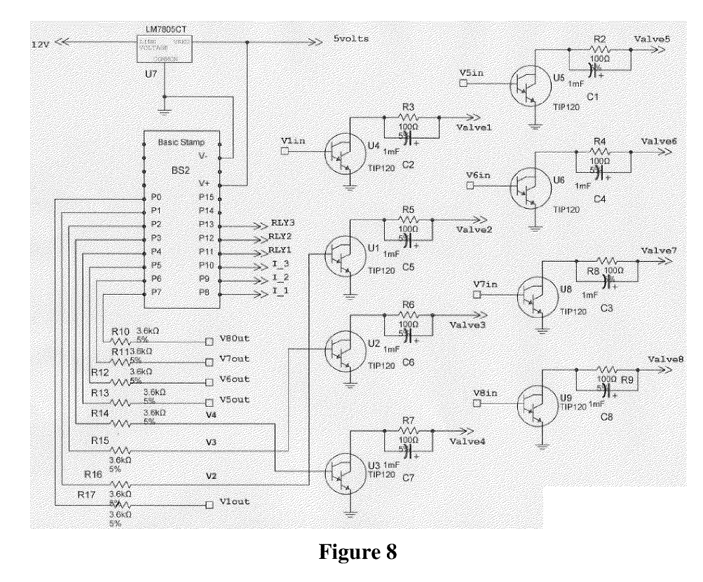

The processing cycle is controlled by a Parallax BS2 Basic Stamp microprocessor integrated circuit as shown in FIG. 8. An LM7805 voltage regulator chip drops the 12 volts down to 5 volts for the BS2. There are eight solenoid valves that are used to fill and drain the cells, which are controlled by ports P0 through P7 on the BS2. These outputs drive the bases of TIP120 Darlington power transistors which in turn activate the valves.

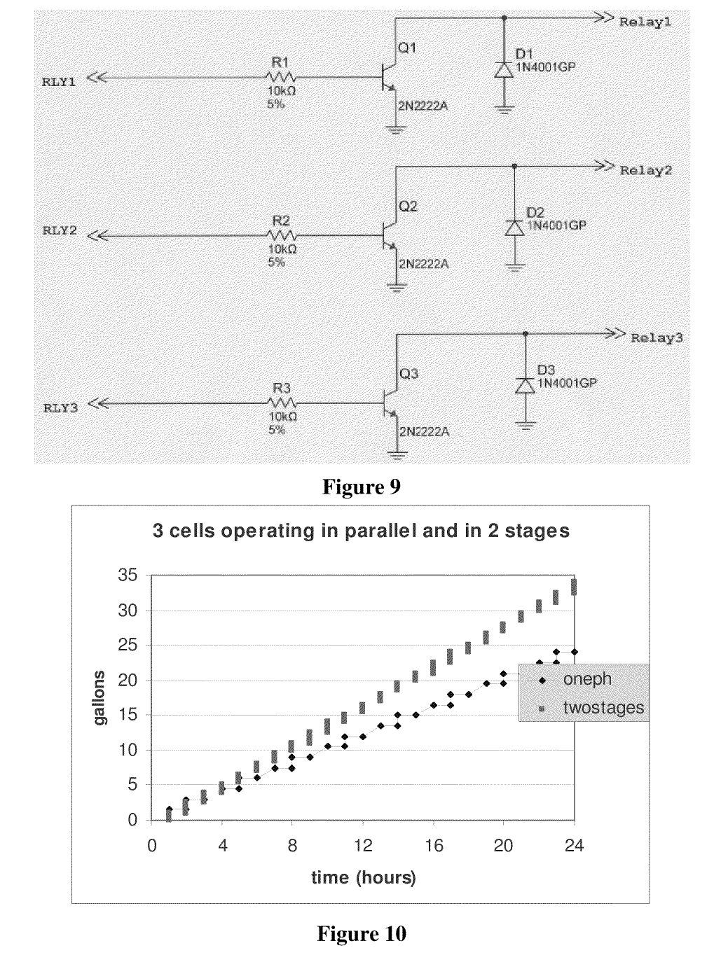

Ports P11, P12, and P13 go to the relay drivers in FIG. 9, which are used to turn the current on and off to the cells. Ports P8, P9, and P10 of FIG. 8 are set up as inputs to monitor the current through the cells.

The advantages of a two-stage system as compared to a single-stage can also be shown in terms of an improved output of water over time. FIG. 10 shows a comparison of a one-stage apparatus with three cells operating in parallel as compared to two-stages with two cells in the first stage and one cell in the second. As shown, the output in gallons over 24 hours is increased from 25 gallons to 35 gallons as one goes from a single-stage purification system to a two-stage purification system.

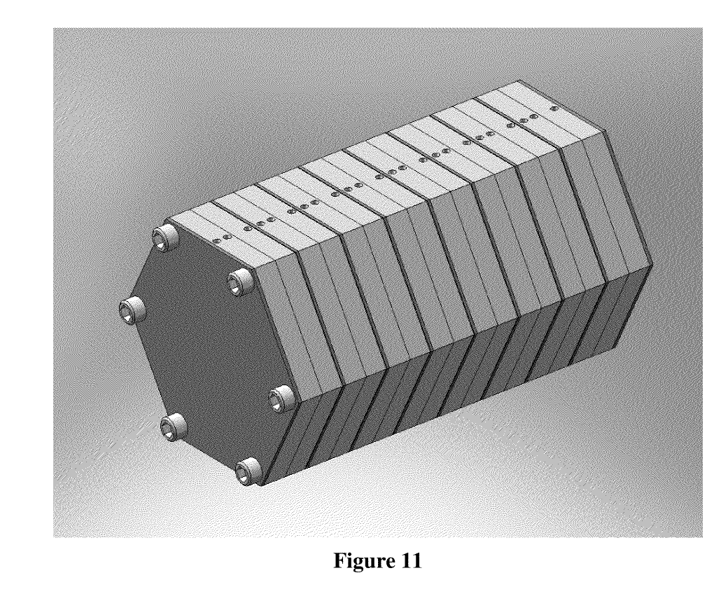

The apparatus can be designed in any desirable configuration, but one particularly practical design is shown as a module in FIG. 11. This element is formed from stacked purification cells and in this case, the module shows eight first-stage cells which will be completed with a set of four second-stage cells. Each completed module will process 272 gallons per day.

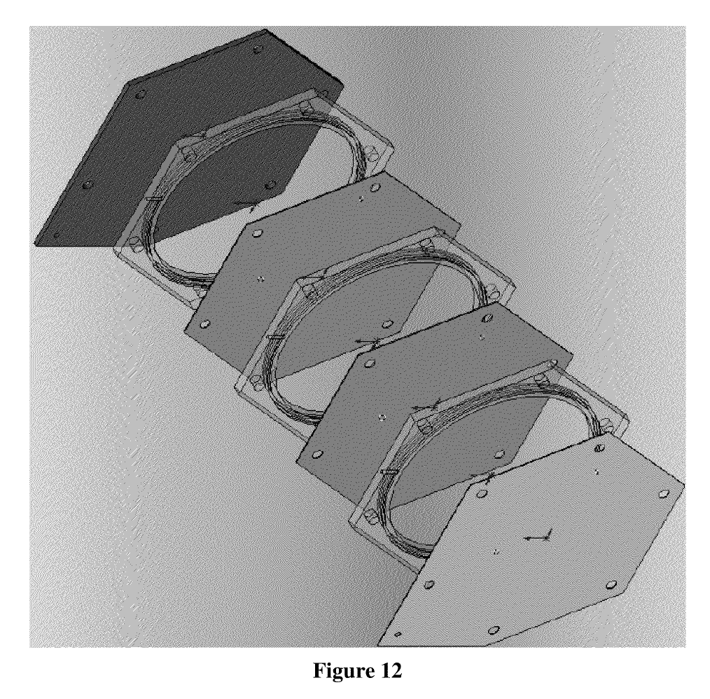

FIG. 12 shows more detail of the construction of the assembly in FIG. 11.

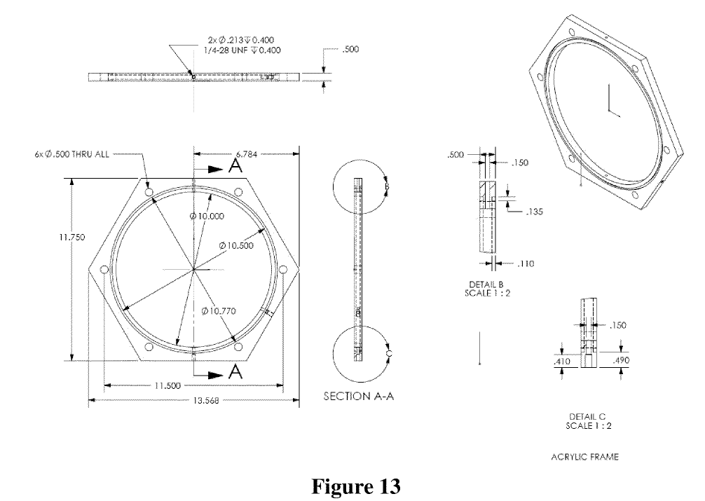

FIG. 13 shows detail of the construction of an individual compartment.

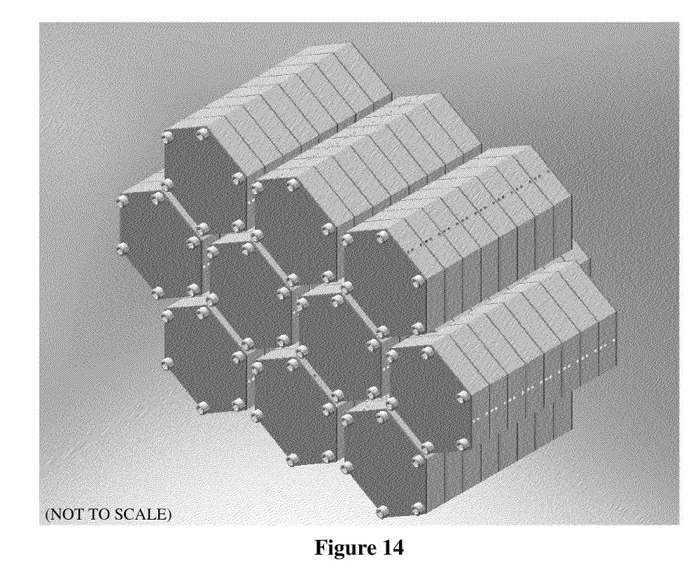

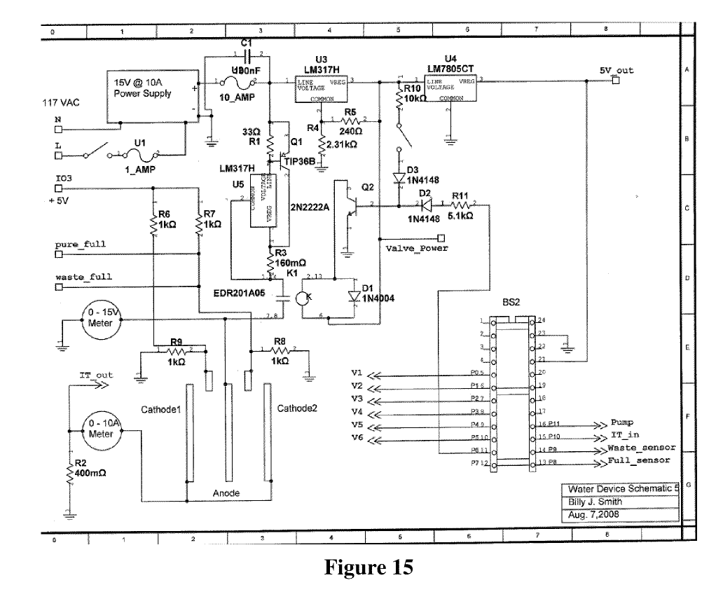

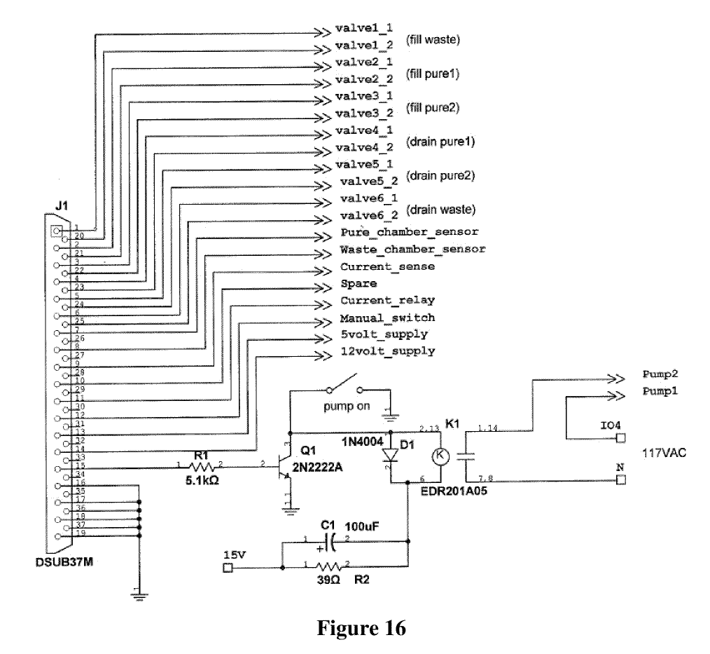

FIG. 14 shows an arrangement of the modules which permits scale-up. Because of the design of the modules, a tight assembly can be achieved.

A two-stage device with 153 modules such as those shown in FIG. 11 arranged as a two-stage purification can process approximately 15,600 gallons per day. The modules themselves are composed of cells which are 50 cm on a side and are 4 cm thick. The conductivity of the water inputted is 21 mSi and the output is 0.7 mSi in the two-stage arrangement.

It may be desirable as well to pretreat the salt-containing water to rid it of other impurities. For example, prefiltration to remove solids is desirable, as well as employing processes to effect precipitation of biological contaminants. One such method employs nanophase manganese (VII) oxide (NM7O) which is bonded to a clay carrier. This material binds organic molecules containing lone pairs of electrons such as compounds containing phosphorous, sulfur, nitrogen and oxygen which are commonly contained in biological contaminants. Addition of NM7O to the water entering the system effects precipitation of algae and other life forms. In this precipitation, NM7O changes from violet to brown thus providing an indicator of the presence of algae in the water. The precipitated algae or other biological forms can then be removed by filtration, sedimentation, or centrifugation.

In addition, the water may be treated at any stage with radiation, including ultraviolet radiation to dispose of live contaminants.

Thus, the apparatus and method of the invention offer a low-cost, efficient way to desalinate water providing water of drinking quality for a multiplicity of scales and settings, including homes, boats, office complexes, hospitals, government facilities, amusement parks and sports facilities. By appropriate scaling, sufficient drinking water for villages or small communities can be provided using the methods of the invention.

The energy required to apply the voltage drop across the parallel deionization cells of the various stages can be supplied, if need be, by fossil fuel. However, more environmentally friendly sources such as solar and wind power may also be used as the voltage differential between anode and cathode is relatively low at 9-12 volts.

1. A method to lower the salt concentration of water, which method comprises
providing water to a deionization cell that comprises a central compartment bracketed by selective ion-passage membranes thus forming two flanking compartments, wherein one said membrane passages only positive ions and the other said membrane passages only negative ions and
subjecting said cell to a voltage differential across said central compartment and flanking compartments,
whereby negative ions cross the membrane into the compartment adjacent the positive electrode and the positive ions flow through the membrane into the compartment adjacent the negative electrode and
whereby the water in the center compartment is deionized, until such time as the rate of flow of the ions across said membrane is decreased when the voltage differential is held constant.

2. The method of claim 1 which further comprises recovering the wastewater from said flanking compartments and employing the wastewater as a battery.

3. The method of claim 1 wherein the water provided is heated to 40°-50° C.

4. An apparatus for water purification which comprises the cells as defined in claim 1, wherein the central compartments of at least two of said cells operating in parallel are fluidly connected to an additional said cell.

5. A method to lower the salt concentration of water which method comprises
subjecting starting water to at least a first stage and second stage of deionization to obtain, at each stage, water at least partially depleted of ion content separate from wastewater with enhanced ion content, and
recovering the wastewater from each stage,
reducing the conductivity of the wastewater, and
recycling said wastewater with reduced conductivity to said first or second stage.

6. An apparatus for the desalinization of brackish water which apparatus comprises
a reservoir for water containing ions;
a conduit for providing the water containing ions to each cell of a first stage that comprises multiplicity of deionization cells arranged in parallel wherein each deionization cell comprises a central compartment bracketed by selective ion-passage membranes thus forming two flanking compartments,
wherein one said membrane passages only positive ions and the other said membrane passages only negative ions; and
wherein said deionization cells are provided a voltage differential orthogonal to the direction of flow of brackish water;
whereby the conductivity of the water in the central compartment of each deionization cell is depleted, and the conductivity of wastewater in the flanking compartments of each deionization cell is enhanced in conductivity;
a conduit connecting the central compartments of each cell of the first stage to a multiplicity of cells in a second stage which are similar or identical to the cells of the first stage and wherein said cells in said second stage are subjected to a voltage differential to effect depletion of conductivity of the water in the center compartment and an enhancement of conductivity of the water in the flanking compartments; and
at least one conduit which permits recovery of water of lower conductivity from the central compartment of cells of the second stage and
conduits which conduct wastewater from the flanking compartments of each first and second stage to a means for precipitating ions sufficiently to permit recycling of said wastewater through the stages of said apparatus.

7. The apparatus of claim 6 wherein the two flanking compartments contain additional membranes.
